(19) United States
(12) Patent Application Publication
(10) Pub. No.: US 2009/0002735 A1
(43) Pub. Date: Jan. 1, 2009

(54) PRINTING CONTROL APPARATUS AND PRINTING SYSTEM

(76) Inventor: Masaki HIGASHIURA, Yamatokoriyama-shi (JP)

Correspondence Address: BIRCH STEWART KOLASCH & BIRCH, PO BOX 747, FALLS CHURCH, VA, 22040-0747, US

(21) Appl. No.: 12/147,080

(22) Filed: Jun. 26, 2008

(30) Foreign Application Priority Data
Jun. 28, 2007 (JP) 2007-169987

(51) Int. Cl. G06F 15/00

(52) U.S. Cl. 358/1.9

(57) ABSTRACT

In order to enable a user to easily perform setting of tandem printing, icons 20 of multiple printing apparatuses 1 which execute the tandem printing are displayed on a screen of a monitor 3 of a printing control apparatus 2. The user performs an operation of drawing a line with respect to the icon 20 of one printing apparatus 1. In response to this operation, a line 21 is drawn on the screen, and the icon 20 of one printing apparatus 1 is isolated from the icons 20 of other printing apparatuses 1. The printing apparatus 1 displayed to be isolated is excluded from targets of the tandem printing.

### BACKGROUND OF THE INVENTION

1. Field of the Invention

The present invention relates to a printing control apparatus in a printing system which can perform tandem printing in which a print job is allocated to multiple printing apparatuses connected through a network and the multiple printing apparatuses perform printing.

2. Description of the Related Art

In a printing system in which multiple printing apparatuses are connected through a network, tandem printing is performed in which one job is allocated to the multiple printing apparatuses and the respective printing apparatuses perform printing. The printing apparatuses which execute the tandem printing are selected from printing apparatuses which have been previously registered.

In Japanese Patent Laid-Open No. 2003-223295, in a host computer, when a printing apparatus is selected from a setting screen, a job ticket including print instruction information is generated. Based on this job ticket, a server allocates a print job to respective selected printing apparatuses The respective printing apparatuses perform printing as instructed, respectively.

In order for a user to confirm the printing apparatuses which perform the tandem printing, it is necessary to read such setting information as the above described job ticket from the server and display the setting information on the screen of the host computer. An operation therefor is required, which is cumbersome for the user. Moreover, if the user hopes to change the printing apparatuses which perform the tandem printing, it is necessary to display the setting information read from the server on the screen of the host computer, change the printing apparatuses, and regenerate the setting information.

In this way, the user has to perform operations many times for setting the tandem printing, resulting in very poor operability. Consequently, in view of the above description, an object of the present invention is to provide a printing system which enables the user to easily perform the setting of the tandem printing.

### SUMMARY OF THE INVENTION

The present invention is a printing control apparatus connected to multiple printing apparatuses through a network, in a printing system in which the respective printing apparatuses share and perform tandem printing, including a user interface with which an input operation can be performed with respect to an icon of the printing apparatus displayed on a screen, and a control section which causes the tandem printing to be executed according to input from the user interface, wherein the control section instructs the printing apparatus the icon of which is displayed, to perform the tandem printing.

The printing apparatus corresponding to the icon displayed on the screen executes the tandem printing. If the icon of the printing apparatus is not displayed on the screen, the printing apparatus does not perform the tandem printing. A user can perform the input operation with respect to the icon on the screen, through the user interface. Thereby, the user can perform an operation with respect to setting of the tandem printing.

In other words, when the input operation has been performed with respect to the icon of the printing apparatus displayed on the screen, the control section changes the setting of the tandem printing with respect to the above described printing apparatus depending on the input.

Prior to or during the execution of the tandem printing, when an operation of excluding the icon of the printing apparatus displayed on the screen has been performed, the control section excludes the above described printing apparatus from targets of the tandem printing. As the operation of excluding, for example, there are an operation of moving the icon of the printing apparatus out of the screen and an operation of adding a drawing been to the icon of the printing apparatus

Moreover, a specific region is displayed on the screen, and there is an operation of putting the icon of the printing apparatus in the specific region. When icons of the multiple printing apparatuses have been put in the specific region, the control section relatively changes display of the icons and display of the specific region. In other words, the control section reduces a size of the icon or increases a size of the specific region, which enables the user to easily confirm the excluded printing apparatus.

When the icons of the multiple printing apparatuses have been grouped, the above described multiple printing apparatuses are excluded. The grouping is performed by selecting the multiple icons. When an operation of excluding this group is performed, the multiple printing apparatuses can be excluded at a time.

When the user has performed any of the above described operations, the above described printing apparatus is excluded from the targets of the tandem printing. In other words, the user can select one or more printing apparatuses which execute the tandem printing.

When the icon of the printing apparatus was excluded during the execution of the tandem printing, the control section instructs a remaining printing apparatus to perform substitute printing. A print job allocated to the excluded printing apparatus is executed by a substitute printing apparatus.

If one printing apparatus has been set as a parent machine, the control section instructs the parent machine to perform the tandem printing. The parent machine is decided from the multiple printing apparatuses. The parent machine allocates the print job or performs the instruction for the execution with respect to the tandem printing. When the parent machine was not set, the control section instructs the respective printing apparatuses to perform the tandem printing. In other words, the printing control apparatus functions as the parent machine.

When the icon of the parent machine was excluded, the control section selects whether the parent machine performs the instruction or the own apparatus performs the instruction. With respect to the tandem printing, whether or not the parent machine constantly performs the instruction has been previously set. When the parent machine was set to constantly perform the instruction, even if the parent machine is excluded, the parent machine performs the instruction. When the parent machine was set not to constantly perform the instruction, and when the parent machine was excluded, the printing control apparatus performs the instruction instead of the parent machine.

When an operation of touching the icon of the printing apparatus displayed on the screen was performed, the control section displays an attribute of the above described printing apparatus. The user can know characteristics or a status of the printing apparatus which executes the tandem printing, by touching the icon on the screen. Thereby, reference for excluding the printing apparatus is provided, which enables the user to perform appropriate exclusion.

When an operation of inputting characters on the icon of the printing apparatus displayed on the screen was performed, the control section recognizes the inputted characters and sets a printing condition for the above described printing apparatus. Thereby, the user can easily perform the setting at the time of the tandem printing, with respect to the printing apparatus.

According to the present invention, since the printing apparatuses which execute the tandem printing are displayed on the screen of the printing control apparatus, the user can comprehend a status of the tandem printing by seeing the screen. Consequently, if the user hopes to perform the setting with respect to the tandem printing, such as the exclusion of the printing apparatus or the changing of the printing condition, the user can easily perform the setting by performing the input operation with respect to the icon on the screen. Thereby, it is possible to construct the printing system with excellent operability.

### BRIEF DESCRIPTION OF THE DRAWINGS

FIG. 1 is a diagram showing a schematic configuration of a printing system of the present invention;

FIG. 2 is a diagram showing a management table related to tandem printing;

FIG. 3 is a diagram showing a screen on which printing apparatuses which execute the tandem printing are displayed;

FIG. 4 is a diagram showing a screen on which a printing apparatus excluded by an operation of a user is displayed;

FIG. 5 is a diagram showing a screen on which a printing apparatus excluded by another operation of the user is displayed;

FIG. 6 is a diagram showing a screen on which a printing apparatus excluded by another operation of the user is displayed;

FIG. 7 is a diagram showing a screen on which a printing apparatus excluded by another operation of the user is displayed;

FIG. 8 is a flowchart of operations of a printing control apparatus when the tandem printing is performed;

FIG. 9 is a flowchart of the operations of the printing control apparatus when the printing apparatus which performs the tandem printing was excluded; and

FIG. 10 is a flowchart of the operations of the printing control apparatus when the printing apparatus was excluded during the execution of the tandem printing.

### DETAILED DESCRIPTION OF THE PREFERRED EMBODIMENT

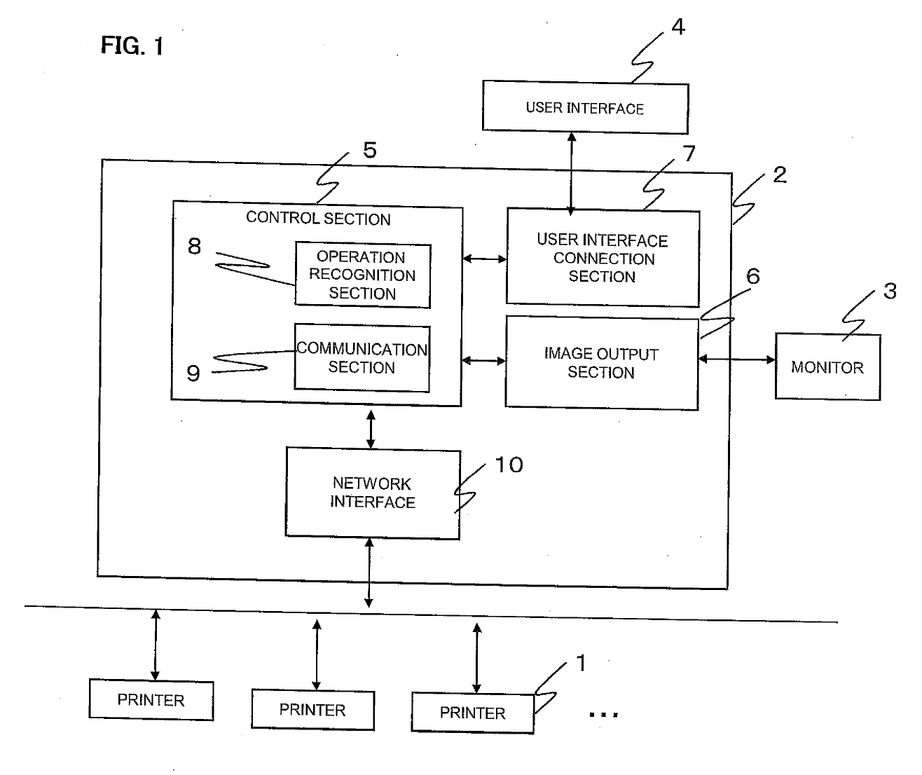

FIG. 1 shows a printing system of this embodiment. The printing system is configured with multiple printing apparatuses 1 and a printing control apparatus 2 which manages the printing apparatuses 1. The respective printing apparatuses 1 and the printing control apparatus 2 are connected so that the respective printing apparatuses 1 and the printing control apparatus 2 can communicate through a network such as a LAN.

The printing apparatus 1 is a printer which prints an image on a recording sheet. It should be noted that the printing apparatus 1 may be a multifunctional peripheral which executes respective processes of copy, print, scan, facsimile communication and document filing. The printing apparatus 1 is provided with a communication interface for communicating with the printing control apparatus 2 and other printing apparatuses 1.

When a print job generated by an information processing apparatus such as a personal computer or another printing apparatus 1 is inputted, the printing apparatus 1 prints the image according to instruction information included in the print job. Moreover, the printing apparatus 1 also generates the print job by reading an image from a document.

The printing control apparatus 2 is a common computer, and is provided with a monitor 3 as a display section, a user interface 4 with which an input operation can be performed with respect to an image displayed on a screen of the monitor 3, and a control section 5 which controls the printing in each printing apparatus 1.

The monitor 3 is a liquid crystal display, and is driven by an image output section 6. When the control section 5 outputs image information to the image output section 6, the image output section 6 outputs a driving signal depending on the image information. On the monitor 3, an operation screen or a setting screen is displayed.

The user interface 4 is a resistive or electromagnetic induction type touch panel. The user interface 4 is placed at a front face of the monitor 3. When a user performs an operation with respect to the image displayed on the screen, the user interface 4 generates an operation signal depending on the operation. The user interface 4 is connected to the control section 5 via a user interface connection section 7. In other words, when the user performs the operation with respect to the image such as an icon displayed on the screen of the monitor 3, with a finger or a pen, the user interface 4 detects a touched position, a moving direction, a time and the like and outputs the operation signal. The operation signal is inputted to the control section 5 via the user interface connection section 7.

The control section 5 has an operation recognition section 8 which analyzes contents of the operation from the inputted operation signal, and a communication section 9 for communicating with the printing apparatus 1 through the network. The operation recognition section 8 recognizes operations of the user, such as an operation of inputting characters, pictures or the like, a click operation and a drag operation, based on the operation signal. The control section 5 generates operation information depending on the contents operated by the user.

When the control section 5 outputs the operation information depending on the operation of the user to the printing apparatus 1, the communication section 9 outputs the operation information to a network interface 10. The network interface 10 transmits the operation information to the printing apparatus 1 according to a predetermined communication protocol.

Then, the control section 5 causes the printing apparatus 1 to execute the print job. The print job includes the instruction information such as image data, a printing condition, and output destination information. The print job is inputted from the printing apparatus 1 or the information processing apparatus, or generated in the own apparatus. In other words, when the control section 5 receives the print job, the control section 5 transmits the print job to a printing apparatus 1 specified as an output destination.

In this printing system, the multiple printing apparatuses 1 perform tandem printing. When the tandem printing is executed, the print job is allocated to the multiple printing apparatuses 1. Then, the divided image data and instruction information are transmitted to the respective printing apparatuses 1, and instruction for the tandem printing is performed. The printing apparatus 1 which has received the instruction prints the image based on the instruction information.

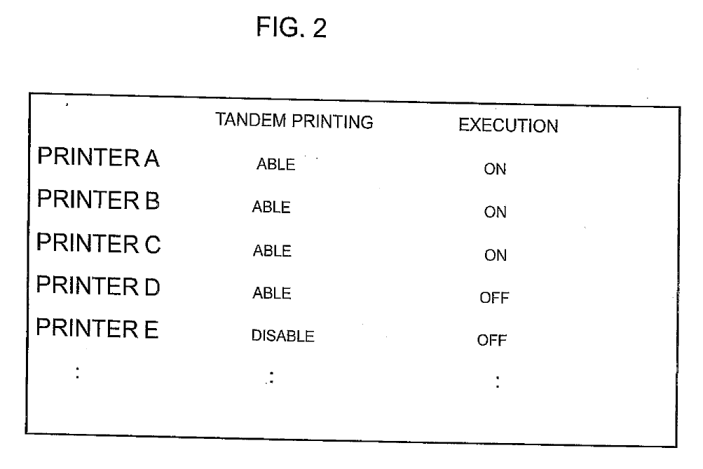

Moreover, the control section 5 generates a management table related to the printing apparatuses 1 belonging to the printing system. The management table is stored in a nonvolatile storage section such as a hard disk apparatus. The management table has attribute information such as performance, an address and an operating status of each printing apparatus 1. The attribute information also includes information on the tandem printing for each printing apparatus 1, as shown in FIG. 2. In other words, the information is able/disable information showing whether or not the printing apparatus 1 is capable of the tandem printing, and execution information showing whether or not the printing apparatus 1 is executing the tandem printing. The printing apparatus 1 capable of the tandem printing has been previously set, and the control section 5 generates the able/disable information depending on this setting and registers the able/disable information in the management table. Moreover, the control section 5 identifies the printing apparatuses 1 which execute the tandem printing, based on the instruction information, and generates the execution information.

Here, one printing apparatus 1 is set as a parent machine from the multiple printing apparatuses 1. Other printing apparatuses 1 become child machines. When the tandem printing is performed, the parent machine allocates the print job to multiple child machines, and instructs the respective child machines to perform the printing. The printing control apparatus 2 registers the printing apparatus 1 which is the parent machine, in the management table. When the tandem printing is performed, the printing control apparatus 2 transmits the print job to the parent machine and requests the tandem printing. The parent machine distributes the print job to the respective child machines as appropriate based on the instruction information. It should be noted that, if the parent machine has not been set, the printing control apparatus 2 functions as the parent machine. In other words, the printing control apparatus 2 allocates the print job to the multiple printing apparatuses 1 and performs the instruction for the printing.

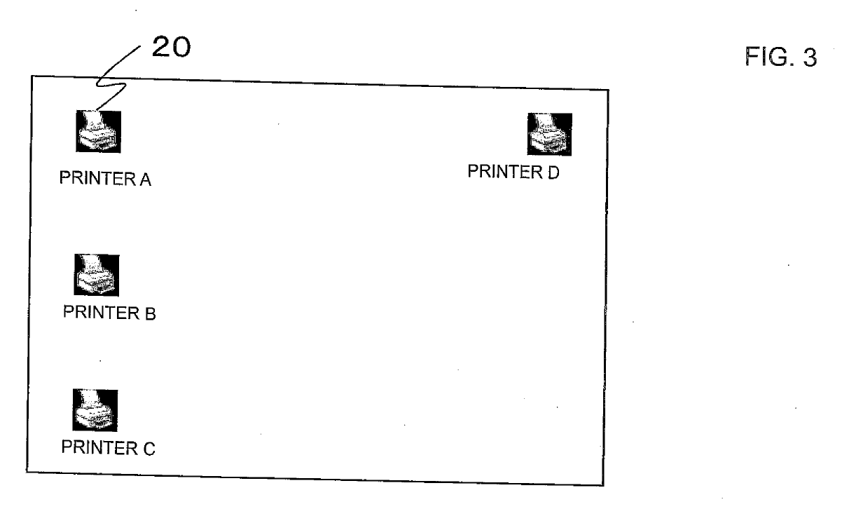

In the printing control apparatus 2, in order to intend to improve user operability when the tandem printing is performed, as shown in FIG. 3, the printing apparatuses 1 which have become targets for the tandem printing are displayed on the screen of the monitor 3. With reference to the management table, the control section 5 identifies the printing apparatuses 1 which perform the tandem printing, and instructs the image output section 6 to display appropriate printing apparatuses 1. The image output section 6 outputs the driving signal for displaying icons 20 for the printing apparatuses 1, to the monitor 3. On the screen of the monitor 3, the icons 20 of the multiple printing apparatuses 1 are displayed. In other words, on the screen, the icons 20 of all printing apparatuses 1 capable of the tandem printing are displayed. The icon 20 of the printing apparatus 1 incapable of the tandem printing is not displayed on the screen. The user can confirm the printing apparatuses 1 capable of the tandem printing, at a glance.

Moreover, when the user has performed the operation with respect to the icon 20 of the printing apparatus 1 displayed on the screen, the tandem printing is performed according to input from the user interface 4. The control section 5 sets or alters the instruction information in the print job, based on the input of the operation signal from the user interface 4 depending on the operation of the user.

Thereby, the user can select the printing apparatuses 1 which perform the tandem printing. In other words, when the user has performed an operation of excluding the icon 20 of the printing apparatus 1 on the screen, the control section 5 excludes the above described printing apparatus 1 from the targets of the tandem printing. At this time, the control section 5 alters the execution information on the excluded printing apparatus 1 in the management table. Then, the control section 5 displays the screen so that the icon 20 of the excluded printing apparatus 1 and the icons 20 of the printing apparatuses 1 which execute the tandem printing are different from each other.

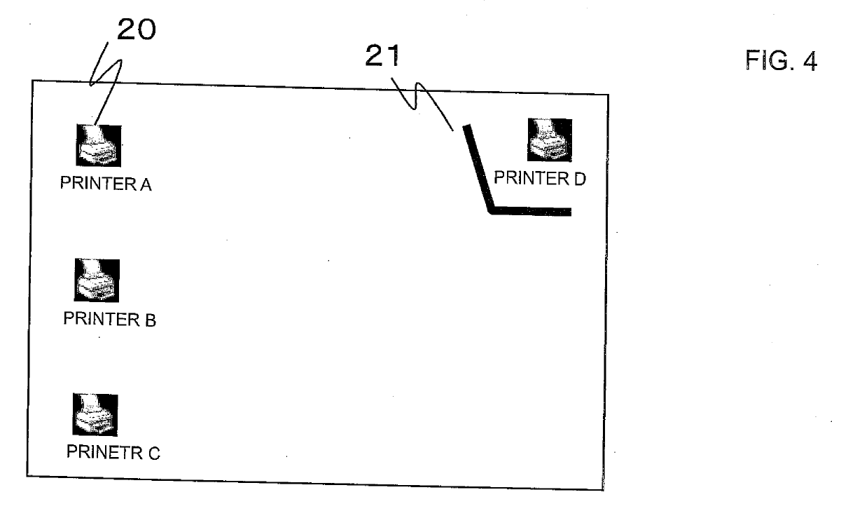

When the user hopes to exclude any of the printing apparatuses 1, as shown in FIG. 4, the user performs an operation of drawing a line with respect to the icon 20 of one printing apparatus 1 so that the icon 20 of one printing apparatus 1 is isolated from other icons 20. The user interface 4 detects this operation and outputs the operation signal. The control section 5 identities the printing apparatus 1 from the inputted operation signal and a position of the icon 20, and determines that the above described printing apparatus 1 has been excluded. At this time, the control section 5 instructs the image output section 6 to display the line drawn by the user on the screen. A line 21 surrounding the icon 20 specified by the user is displayed on the screen. Moreover, when the user has performed an operation of drawing a frame so that the frame surrounds multiple icons 20, the control section 5 excludes the multiple printing apparatuses 1 specified by the user.

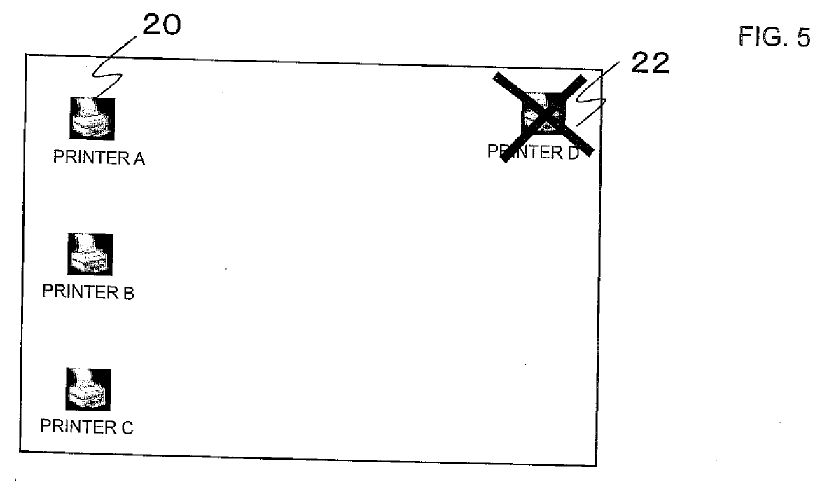

As another operation for the exclusion, as shown in FIG. 5, the user draws a mark such as “x” on the icon 20 on the screen. Also in this case, the control section 5 identifies the marked printing apparatus 1 based on the operation signal from the user interface 4, and excludes the above described printing apparatus 1. Then, a mark 22 is displayed on the icon 20 on the screen. It should be noted that, instead of displaying the mark 22, a color of the icon 20 may be changed so that the icon 20 can be distinguished from other icons 20.

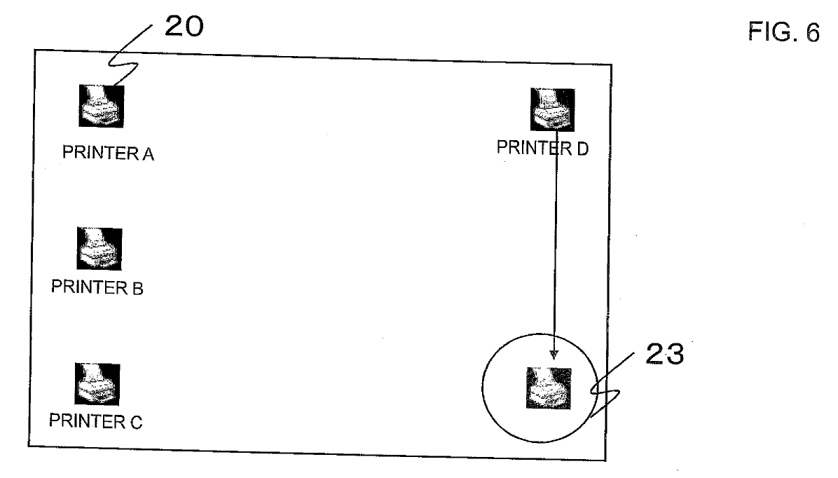

Furthermore, as shown in FIG. 6, a trash box region 23 has been formed as a specific region for the exclusion on the screen. The user performs an operation of dragging the icon 20 and putting the icon 20 in the trash box region 23. Based on the operation signal from the user interface 4, the control section 5 excludes the printing apparatus 1 corresponding to the icon 20 put in the trash box region 23. Then, the icon 20 being dragged is displayed, and eventually the icon 20 is displayed within the trash box region 23.

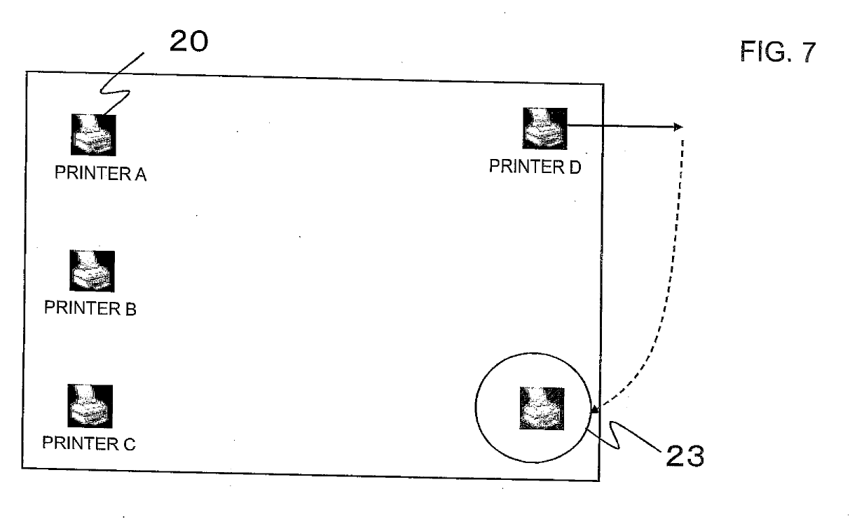

Moreover, as shown in FIG. 7, the user drags the icon 20 on the screen so that the icon 20 is put out of the screen. The control section 5 excludes the printing apparatus 1 corresponding to the operated icon 20. Then, the icon 20 of the above described printing apparatus 1 is displayed in the trash box region 23.

When the user performs an operation of selecting the multiple icons 20, these icons 20 are grouped. Then, if the user performs an operation of excluding this group, such as dragging this group to the trash box region 23, the user can collectively exclude the multiple printing apparatuses 1.

When the multiple printing apparatuses 1 were excluded, the multiple icons 20 exist within the trash box region 23. At this time, in order to enable the user to easily confirm the icons 20, the control section 5 relatively changes display of the trash box region 23 and display of the icons 20. For example, a size of the icon 20 is not changed, and a size of the trash box region 23 is increased. Conversely, the size of the trash box region 23 is not changed, and the size of the icon 20 is reduced. Thereby, the multiple icons 20 are displayed so that the multiple icons 20 may not be overlapped or only some of the multiple icons 20 may be overlapped. Therefore, the user can visually recognize all excluded icons 20.

When an operation of excluding the multiple printing apparatuses I and retaining only one printing apparatus 1 is performed, the control section 5 instructs one printing apparatus 1 to perform the printing. In other words, only one printing apparatus 1 executes the printing. When the user does not hope to perform the tandem printing, the user may perform such an operation.

When an operation of returning the icon 20 to its original state was performed with respect to the icon 20 of the excluded printing apparatus 1, the control section 5 sets the above described printing apparatus 1 as the printing apparatus 1 which executes the tandem printing. Then, the display of the icon 20 on the screen is also returned to its original display.

When the user has performed an operation of touching the icon 20 displayed on the screen, the user interface 4 generates the operation signal depending on this operation. In response to this operation signal, the control section 5 controls the image output section 6 to display the attribute information on the printing apparatus 1 corresponding to the touched icon 20. On the screen, an attribute screen representing the attribute information on the printing apparatus 1 is displayed. Thereby, the user can confirm whether or not the printing apparatus 1 is appropriate for executing the tandem printing. Then, when the user decides the printing apparatus 1 to be excluded, the user can use this attribute information to select an appropriate printing apparatus 1.

Moreover, when the user has performed an operation of inputting the characters or numbers on the icon 20 on the screen, the control section 5 recognizes contents of the input and sets the instruction information in the print job. The user performs an operation of drawing the characters or the numbers which have been previously registered, on the icon 20. The user interface 4 generates the operation signal depending on this operation. Based on this operation signal, the control section 5 recognizes the specified printing apparatus 1, also recognizes the inputted characters or numbers, and sets the printing condition in the above described printing apparatus 1. Then, the control section 5 generates the instruction information according to the set printing condition. It should be noted that, if the inputted printing condition has been already set, the inputted printing condition is set again.

For example, when the numbers are inputted, the number of copies to be printed is set. When “double side” is inputted, double-sided printing is set. When “2up” is inputted, a printing condition of aggregating two pages into one page is set. Thereby, the printing condition depending on an object of the user can be set, which can improve the user operability.

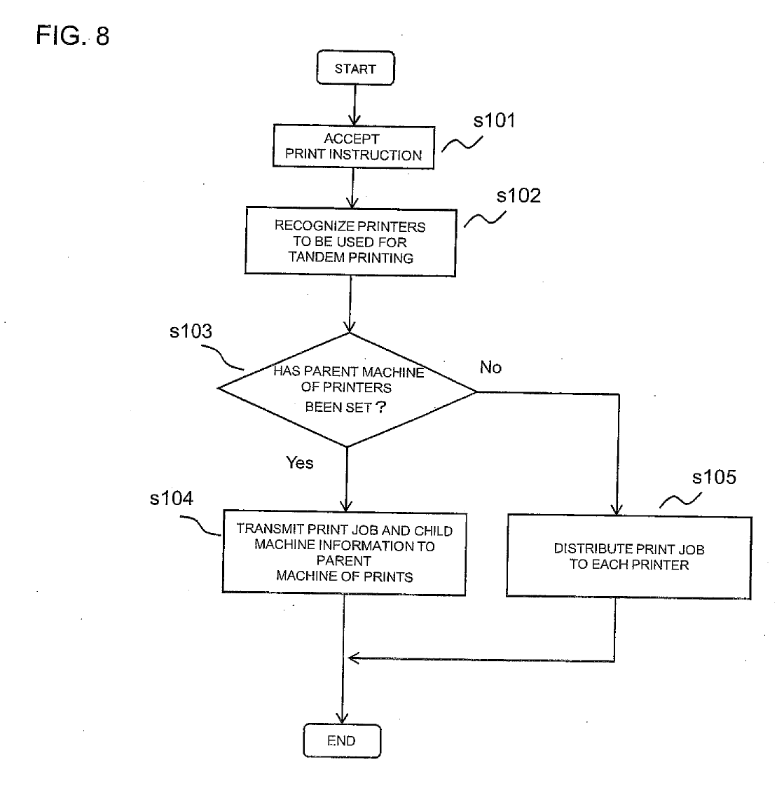

Next, operations of the printing control apparatus 2 when the tandem printing is performed will be described. As shown in FIG. 8, the printing control apparatus 2 accepts the print instruction when the print job is inputted from outside (S101). The control section 5 recognizes that the instruction is for the tandem printing, from the instruction information in the print job, and searches the printing apparatus 1 capable of the tandem printing based on the able/disable information in the management table. Then, the control section 5 controls the image output section 6 to display all printing apparatuses 1 capable of the tandem printing. As shown in FIG. 3, the icons 20 of the multiple printing apparatuses 1 are displayed on the screen (S102). The displayed printing apparatuses 1 execute the tandem printing.

The control section 5 confirms whether or not the parent machine has been set (S103). If the parent machine has been set, the control section 5 transmits the print job and child machine information to the parent machine (S104). The child machine information is generated based on the execution information in the management table.

When the parent machine receives the print job, the parent machine divides the print job for each printing apparatus 1 which is the child machine, including the own apparatus, based on the instruction information and the child machine information, and transmits the print job to each printing apparatus 1. The respective printing apparatuses 1 including the parent machine print the image as instructed, respectively.

If the parent machine has not been set, the control section 5 divides the print job for each printing apparatus 1, and transmits the print job to each printing apparatus 1 (S105). The respective printing apparatuses 1 print the image as instructed, respectively.

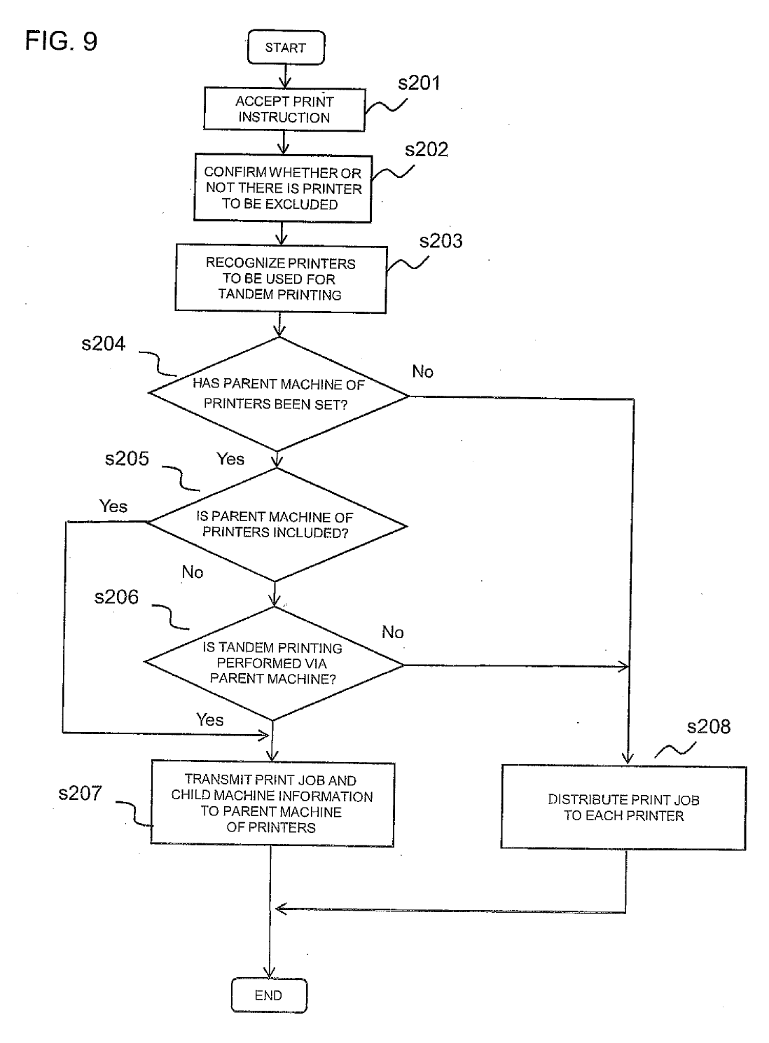

Incidentally, the user can select the printing apparatuses 1 which perform the tandem printing. In this case, as shown in FIG. 9, when the printing control apparatus 2 receives the print instruction (S201), the control section 5 causes the printing apparatuses 1 which execute the tandem printing to be displayed based on the execution information. The user performs the operation of excluding one or more icons 20 from the icons 20 of the multiple printing apparatuses 1 displayed on the screen. The user interface 4 outputs the operation signal depending on this operation to the control section.

When the operation signal from the user interface 4 is inputted, the control section 5 confirms that the operation of excluding the printing apparatus 1 has been performed (S202). Then, the control section 5 identifies the excluded printing apparatus 1 based on the operation signal, and recognizes the printing apparatuses 1 which execute the tandem printing (S203). At this time, the execution information in the management table is rewritten. Moreover, on the screen, the icon 20 of the excluded printing apparatus 1 is displayed in a form different from the icon 20 of the printing apparatus 1 which executes the tandem printing.

The control section 5 confirms whether or not the parent machine has been set, based on the management table (S204). If the parent machine has been set, the control section 5 determines whether or not the parent machine is included in the printing apparatuses 1 which execute the tandem printing, based on the execution information (S205). When the parent machine executes the tandem printing, the control section 5 transmits the print job and the child machine information to the parent machine (S207).

When the parent machine receives the print job, the parent machine divides the print job for each printing apparatus 1 including the own apparatus, based on the instruction information and the child machine information, and transmits the print job to each printing apparatus 1. The respective printing apparatuses 1 including the parent machine print the image as instructed, respectively.

If the parent machine has been excluded, the parent machine does not execute the tandem printing. At this time, the control section 5 determines whether or not to perform the tandem printing via the parent machine (S206). If the parent machine has been set, whether or not the printing control apparatus 2 is substituted for the parent machine has been previously set.

If the parent machine is not included in the printing apparatuses 1 which execute the tandem printing, when the printing control apparatus 2 was set not to be substituted for the parent machine, the control section 5 transmits the print job and the child machine information to the parent machine (S207). When the parent machine receives the print job, the parent machine divides the print job for each printing apparatus 1, based on the instruction information and the child machine information, and transmits the print job to each printing apparatus 1. The respective printing apparatuses 1 print the image as instructed, respectively.

If the parent machine has not been set, or if the parent machine has been set, but the parent machine is excluded and the printing control apparatus 2 is substituted for the parent machine, the control section 5 divides the print job for each printing apparatus 1, and transmits the print job to each printing apparatus 1 (S208). The respective printing apparatuses 1 print the image as instructed, respectively.

In the above description, before the tandem printing is started, the user selects the printing apparatuses 1 which execute the tandem printing. During the execution of the tandem printing, the printing apparatus 1 can also be changed In other words, during the execution of the tandem printing, the icons 20 of the printing apparatuses 1 executing the tandem printing are displayed on the screen of the monitor 3. The user performs the operation of excluding the icon 20 of the printing apparatus 1.

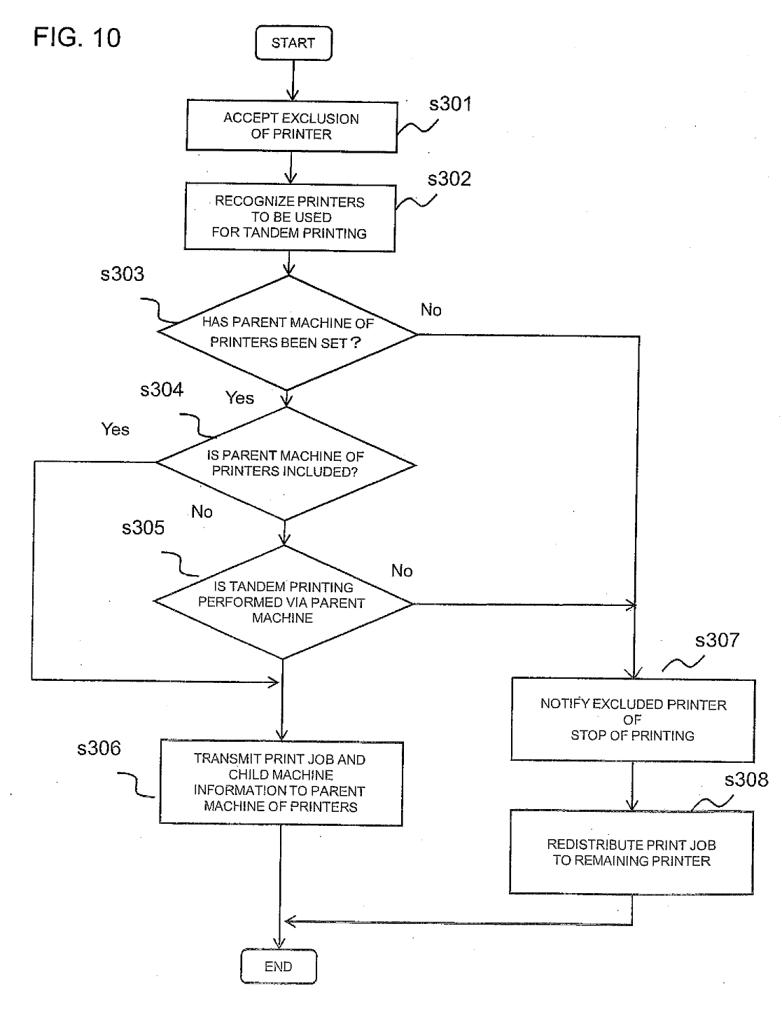

As shown in FIG. 10, the control section 5 accepts the exclusion of the printing apparatus 1 through the operation signal from the user interface 4 (S301) Then, the control section 5 recognizes that the printing apparatus 1 executing the tandem printing has been excluded. Operations at S302 and subsequent steps are the same as the operations at S203 and subsequent steps shown in FIG. 9.

However, since the printing apparatus 1 executing the tandem printing has been excluded, another printing apparatus 1 performs substitute printing. Instruction for the substitute printing is performed by the parent machine or the printing control apparatus 2. If the parent machine has been set, the instruction for the substitute printing is performed by the parent machine. If the parent machine has not been set, or if the parent machine has been set, but the parent machine is excluded and the printing control apparatus 2 is substituted for the parent machine, the instruction for the substitute printing is performed by the printing control apparatus 2.

In the substitute printing, the parent machine or the control section 5 of the printing control apparatus 2 notifies the excluded printing apparatus 1 of stop of the printing (S307). Then, the print job allocated to the excluded printing apparatus 1 is redistributed to another printing apparatus 1 (S308). It should be noted that one or more other printing apparatuses 1 are selected from the remaining printing apparatuses 1 which execute the tandem printing. The excluded printing apparatus 1 stops the printing. Another printing apparatus 1 which has received the instruction prints the image according to the redistributed print job.

As described above, since the printing apparatuses 1 corresponding to the icons 20 displayed on the screen execute the tandem printing, the user can know a status of the tandem printing by seeing the screen. Moreover, it is possible to cause the printing apparatuses 1 which are convenient for the user, to execute the tandem printing, by performing the operation of excluding the printing apparatus 1 with respect to the screen. In addition, since the printing condition can also be set on the screen, the setting of the tandem printing can be easily performed and convenience for the user can be improved.

It should be noted that the present invention is not limited to the above described embodiment, and of course, it is possible to add many modifications and alterations to the above described embodiment within the range of the present invention. The printing control apparatus may be a printing apparatus having a user interface. As the user interface, a cursor may be displayed on the screen of the monitor and a pointing device such as a mouse for operating the cursor may be used.

What is claimed is:

1. A printing control apparatus connected to multiple printing apparatuses through a network, in a printing system in which the respective printing apparatuses share and perform tandem printing, the printing control apparatus comprising:
a user interface with which an input operation can be performed with respect to an icon of the printing apparatus displayed on a screen; and
a control section which causes the tandem printing to be executed according to input from the user interface,
wherein the control section instructs the printing apparatus the icon of which is displayed, to perform the tandem printing.

2. The printing control apparatus according to claim 1, wherein when an operation of excluding the icon of a printing apparatus displayed on the screen was performed, the control section excludes said printing apparatus from targets of the tandem printing.

3. The printing control apparatus according to claim 2, wherein when an operation of moving the icon of a printing apparatus out of the screen was performed, said printing apparatus is excluded.

4. The printing control apparatus according to claim 2, wherein when an operation of adding a drawing to the icon of a printing apparatus was performed, said printing apparatus is excluded.

5. The printing control apparatus according to claim 2, wherein when a specific region is displayed on the screen and an operation of putting the icon of a printing apparatus in the specific region was performed, said printing apparatus is excluded.

6. The printing control apparatus according to claim 5, wherein when icons of multiple printing apparatuses were put in the specific region, the control section relatively changes display of the icons and display of the specific region.

7. The printing control apparatus according to claim 6, wherein the control section reduces a size of the icon or increases a size of the specific region.

8. The printing control apparatus according to claim 2, wherein when the icons of multiple printing apparatuses were grouped, said multiple printing apparatuses are excluded.

9. The printing control apparatus according to claim 2, wherein when the icon of a printing apparatus was excluded during the execution of the tandem printing, the control section instructs remaining printing apparatus to perform substitute printing.

10. The printing control apparatus according to claim 9, wherein one printing apparatus is set as a parent machine, and the control section instructs the parent machine to perform the tandem printing.

11. The printing control apparatus according to claim 10, wherein when any parent machine was not set, the control section instructs respective printing apparatuses to perform the tandem printing.

12. The printing control apparatus according to claim 10, wherein when the icon of the parent machine was excluded, the control section selects whether the parent machine performs the instruction or the own apparatus performs the instruction.

13. The printing control apparatus according to claim 9, wherein when an operation of touching the icon of a printing apparatus displayed on the screen was performed, the control section displays an attribute of said printing apparatus.

14. The printing control apparatus according to claim 9, wherein when an operation of inputting characters on the icon of a printing apparatus displayed on the screen was performed, the control section recognizes the inputted characters and sets a printing condition for said printing apparatus.

15. A printing system in which multiple printing apparatuses and a printing control apparatus which manages the respective printing apparatuses are connected through a network, and the respective printing apparatuses share and perform tandem printing, said printing control apparatus comprising:
a user interface with which an input operation can be performed with respect to an icon of the printing apparatus displayed on a screen; and
a control section which causes the tandem printing to be executed according to input from the user interface,
wherein the control section instructs the printing apparatus the icon of which is displayed, to perform the tandem printing.

16. The printing system according to claim 15, wherein when the input operation was performed with respect to the icon of a printing apparatus displayed on the screen, the control section performs setting of the tandem printing with respect to said printing apparatus depending on the input.
